(19) United States
(12) Patent Application Publication
(10) Pub. No.: US 2008/0317627 A1
(43) Pub. Date: Dec. 25, 2008

(54) CHEMILUMINESCENCE ANALYZER

(76) Inventors: Masataka SHIRAI, Higashimurayama (JP); Tomoharu KAJIYAMA, Higashiyamato (JP); Hideki KAMBARA, Hachioji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/142,839

(22) Filed: Jun. 20, 2008

(30) Foreign Application Priority Data
Jun. 21, 2007 (JP) 2007-164175

(51) Int. Cl. G01N 21/76

(52) U.S. Cl. 422/52

(57) ABSTRACT

The present invention aims to achieve both rapid supply of reagent substances to micro-chambers and inhibition of contamination from adjacent chambers. For achieving the above objects, the shape of a flow channel in a flow cell including a plate having micro-chambers is varied between the time of substance supply and the time of luminescence reaction.

### CLAIM OF PRIORITY

The present application claims priority from Japanese application JP 2007-164175 filed on Jun. 21, 2007, the content of which is hereby incorporated by reference into this application.

### BACKGROUND OF THE INVENTION

1. Field of the Invention

The present invention relates to a chemiluminescence analyzer, and, in particular, relates to a chemiluminescence analyzer with which analysis of gene sequences, analysis of gene polymorphism, analysis of genetic mutations, analysis of gene expression, and the like can be performed.

2. Description of the Related Art

For determination of DNA sequences, a method using gel electrophoresis and fluorescence detection has been widely used. In this method, firstly, a large number of copies of a DNA fragment to be analyzed for its sequence are prepared. Starting at the 5′ end of the DNA fragment, fluorescence-labeled fragments having various lengths are prepared. In this preparation, fluorescence labels having different fluorescence wavelengths are attached to these fragments according to their bases at the 3′ end. In gel electrophoresis, single-base differences in length are discriminated among these fragments, and fluorescence emitted from each of groups of fragments having the same length is detected. On the basis of fluorescence wavelength (color), a terminal base of a group of DNA fragments being measured can be acquired. DNA fragments sequentially go through a fluorescence detection part in order of increasing size from smaller to larger. Accordingly, terminal bases of the respective DNA fragments can be acquired in order of increasing DNA fragment size from shorter to longer by detecting their fluorescent colors. In this process, the sequence is determined. Such a fluorescence DNA sequencer has been widely used, and largely contributed to human genome analysis. According to this method, Anal. Chem. 2000, 72, 3423-3430 discloses a technique for increasing the capacity of analysis per machine by using a large number of glass capillaries having an internal diameter of approximately 50 μm and by further applying a terminal end detection method and the like.

In the meantime, a sequence determination method based on a stepwise chemical reaction (for example, International Publication Nos. WO 98/13523 and WO 98/28440), which is a method represented by pyrosequencing, has been drawing attention because of its simple and easy handling. The outline of this method is as follows: a target DNA chain is hybridized with a primer; four kinds of nucleic-acid substrates for synthesis of complementary strand (dATP, dCTP, dGTP, and dTTP) are added individually and sequentially to a reaction solution for a reaction for synthesis of complementary strand. In the complementary strand synthesizing reaction, a DNA complementary chain is elongated, and, as a result, pyrophosphoric acid (PPi) is produced as a by-product. PPi is converted to adenosine triphosphatase (ATP) by the action of an enzyme in the reaction system, and the ATP reacts with luciferin and O₂ in the coexistence of luciferase and the luciferin, resulting in emission of light. Detection of the light indicates that an added substrate for synthesis of complementary strand has been incorporated into the DNA chain. Therefore, sequence information of the complementary chain, and accordingly sequence information of the target DNA chain, can be acquired.

This method can be applied to a flow-through analysis, and a technique which utilizes this method for greatly increasing the capacity of analysis is reported by Marguilies M, et al. in “Genome sequencing in microfabricated high-density picolitre reactors” Nature, Vol. 437, Sep. 15; 2005, pp 376-80 and Supplementary Information s1-s3. The technique uses a flow-through cell which has multiple picolitre-size wells formed on the entire surface of the cell. Multiple identical molecules which have been obtained by hybridizing a primer to a target DNA chain are fixed on the surface of a sepharose bead having a diameter of approximately 35 μm, and the bead and a bead having a bioluminescence enzyme (luciferase) and the like fixed thereon are filled in each of the micro-chambers inside the flow cell. In order to prevent these beads from flowing out, microparticles each having a diameter of 0.8 μm are filled into each of the micro-chambers. These beads are filled in the micro-chambers by injecting a bead-containing solution into the flow cell, and then by sedimenting the beads into each of the micro-chambers by use of a centrifuge. For analysis, four kinds of nucleic-acid substrates for synthesis of complementary strand (dATP, dCTP, dGTP, and dTTP) are consecutively injected from the upstream of the flow cell, and bioluminescence emitted upon injection of each of the substrates is observed.

In these techniques, a picotiter plate is prepared by use of a fiber-optic faceplate, and used as a part of a flow cell (for example, Electrophoresis 2003, 24, 3769-3777). A large number of micro-chambers are formed on the picotiter plate (hereinafter abbreviated to “plate”), a target DNA to be analyzed is fixed on individual beads, the beads are respectively inserted into the micro-chambers, and then an elongation reaction of the DNA and a chemiluminescence reaction accompanying the elongation reaction are caused to proceed in the individual micro-chambers. In this method, the types of DNA to be analyzed at once can be increased by increasing the number of micro-chambers; thus, it is possible to largely improve the throughput. However, if micro-chambers are arranged at a high density in order to analyze a large number of DNA at once, there would arise a problem of contamination of a substance produced in the individual micro-chambers in the plate, specifically PPi, diffusing in a transverse direction. This results in impaired measuring accuracy. Use of a plate to which a membrane and the like are provided in order to prevent contamination from adjacent micro-chambers is disclosed in International Publication No. WO 03/004690. Meanwhile, Marguilies et al. discloses the method in which a bead having a target DNA to be analyzed fixed thereon and a bead having an enzyme required for chemiluminescence is fixed thereon are firstly inserted into a micro-chamber, and then packing beads serving like the membrane are packed into the micro-chamber.

As for a reagent applicable to a pyrosequencing reaction, a reaction system different from the above-described technique is disclosed in Japanese Patent Application Publication No. Hei. 9-234099. In this technique, adenosine monophosphatase (AMP) and pyrophosphate decahydrate (PPi) are caused to react with each other to form ATP in the reverse reaction of pyruvate orthophosphatase dikinase (PPDK), and the concentration of the ATP thus formed is measured.

### SUMMARY OF THE INVENTION

The throughput of analysis can be dramatically increased by adopting the technique of pyrosequencing using a flow-through type reaction plate having multiple micro-chambers arranged side by side thereon, compared to conventional gel electrophoresis. In this technique, DNA analysis is carried out by detecting chemiluminescence generated by reactions occurring in each of the micro-chambers on the plate. To be more specific, while a target DNA to be analyzed (reactant) is either fixed on individual beads to be inserted into the respective micro-chambers, or directly fixed inside the individual micro-chambers, a reagent containing at least a reactive substrate is injected into the large number of micro-chambers to cause a reaction. PPi which is a product of the reaction is converted to ATP in a series of reactions. Consecutively, the ATP further causes a luminescence reaction of luciferin by luciferase serving as an enzyme catalyzing, and the luciferin emitting light is detected. In this technique, there has been a problem that the accuracy of determination of sequences or detection of DNA is impaired when PPi or ATP, which is a product of the reaction in individual micro-chambers, gets into neighboring chambers (occurrence of crosstalk). To be more specific, PPi produced during DNA elongation diffuses to adjacent micro-chambers, and luminescence is observed as if there were an elongation reaction in the adjacent micro-chambers, resulting in detection of false luminescence intensities.

For coping with this problem, a membrane and packing beads may be used to prevent products of elongation reaction from diffusing. However, if such measures are taken, it is impossible to rapidly supply substances required for elongation of DNA and chemiluminescence into the inside of individual micro-chambers, and to remove excess reaction substrates. In other words, there has been a problem that a DNA complementary strand synthesizing reaction cannot proceed uniformly, though the uniform reaction is critical for increasing the accuracy of DNA analysis.

An object of the present invention is to achieve both: rapid supply and discharge of reagents containing reactive substrates to the individual micro-chambers; and elimination of cross talk among adjacent chambers. If rapid supply of reactive substrates and discharge of excess substrates or discharge of a product of a reaction cannot be carried out sufficiently, an elongation reaction cannot proceed uniformly in the individual micro-chambers. In such a case, some DNA chains with which a reaction has been quenched and surplus nucleic-acid substrate dNTPs in the DNA supplementary strand elongation reactions may remain in the individual chambers, adversely affecting the following complementary strand synthesis reaction and the like. As a result, there is a problem of inaccurate determination of DNA sequences. In addition, for the purpose of allowing analysis to be performed even with a small number of target DNA molecules, it is also important to prevent a reaction product during elongation from diffusing outside of the micro-chambers. This is because such diffusion causes a reduction of an effective concentration of chemical substances required for luminescence, resulting in weaker luminescence intensity.

In order to meet these incompatible demands, the present invention provides a means for changing either conductance or a cross-sectional shape of a flow channel of a flow cell provided with a plate having micro-chambers formed thereon between the time of supply or discharge of substances and the time of luminescence reaction.

To be more specific, in a flow cell having a configuration in which a flow channel is formed between a plate having micro-chambers formed thereon and a transparent substrate (upper plate) arranged to face the plate, and a solution (reagent) containing a reactive substrate is supplied to the individual micro-chambers through this flow channel, a means for changing the distance between the transparent substrate and the plate is provided. The micro-chambers are each formed as a concave portion on the plate. When the plate and the transparent substrate which determine a flow channel are located sufficiently far apart from each other, a reagent can freely flow in the flow cell. Accordingly, a necessary reagent can be supplied to the individual micro-chambers, and an unwanted chemical substance can be discharged from the micro-chambers. On the other hand, by either making the distance between the plate and the transparent substrate sufficiently small or attaching them completely to each other, PPi and ATP which have been produced in elongation reaction can either hardly diffuse to the outside of the individual micro-chambers or not diffuse at all. In other words, by changing the distance between the plate and the transparent substrate which determine the thickness of the flow channel of the flow cell, it is possible to achieve both rapid supply of a reaction solution and discharge of an unwanted chemical substance, and prevention of substances produced in an elongation reaction from diffusing to the outside of the individual micro-chambers. In this case, enzymes, such as luciferase and PPDK, are required for the luminescence reaction. Such enzymes may be fixed in the individual chambers, or mixed into a reagent and supplied at every addition of the reagent.

In another method, a second substrate is provided between the plate and the transparent substrate. By providing a means for bringing the second substrate closer to the micro-chambers or for expanding the second substrate, diffusion of a substance accompanying an elongation reaction from the individual micro-chambers can be prevented. It may also be configured that the second substrate has opening portions formed thereon. In such a configuration, supply of a chemical substance to the micro-chambers can be achieved by adjusting the position of the opening portions to the position of the respective micro-chambers, while diffusion of a chemical substance accompanying an elongation reaction is prevented by displacing the position of the opening portions from the position of the respective micro-chambers. The diffusion may also be prevented by providing an on-off valve near the border between the micro-chambers and the flow channel.

According to the present invention, highly-accurate DNA analysis based on a stepwise reaction can be performed in nucleic acid analysis, especially analysis of gene sequences. Furthermore, with such DNA analysis, the throughput of the analysis and measurement sensitivity can be successfully improved. Especially, with the improvement in measurement sensitivity, a sufficient level of sensitivity can be achieved even if an amount of molecules obtained is not sufficient even with amplification by PCR (Polymerase Chain Reaction) and the like in the case where only a single molecule is a target for measurement.

### BRIEF DESCRIPTION OF THE DRAWINGS

FIG. 1 is a drawing illustrating a configuration example of a chemiluminescence analyzer according to the present invention.

FIGS. 2A and 2B are schematic cross-sectional views illustrating a configuration example of a flow cell.

FIG. 3 is an exploded view of the flow cell.

FIGS. 4A, 4B, and 4C are schematic views of a bead to which a sample DNA is fixed.

FIG. 5 is a flowchart showing a procedure of determination of DNA sequences.

FIGS. 6A and 6B are schematic views of luminescence images.

FIG. 7 is a schematic cross-sectional view of another example of the flow cell.

FIGS. 8A and 8B are schematic cross-sectional views of another example of the flow cell.

FIGS. 9A and 9B are schematic cross-sectional views of another example of the flow cell.

FIGS. 10A and 10B are schematic cross-sectional views of another example of the flow cell.

FIG. 11 is a drawing illustrating a configuration example of a chemiluminescence analyzer according to the present invention.

FIGS. 12A and 12B are schematic cross-sectional views of another example of a flow cell.

FIGS. 13A, 13B, and 13C are schematic views of another example of the flow cell.

FIGS. 14A and 14B are schematic views of another example of the flow cell.

FIGS. 15A and 15B are schematic cross-sectional views of another example of the flow cell.

FIGS. 16A and 16B are schematic cross-sectional views of another example of the flow cell.

FIGS. 17A and 17B are schematic cross-sectional views of another example of the flow cell.

FIG. 18 is a schematic cross-sectional view of another example of the flow cell.

FIG. 19 is a schematic cross-sectional view of another example of the flow cell.

FIG. 20 is a schematic cross-sectional view of another example of the flow cell.

### DESCRIPTION OF THE PREFERRED EMBODIMENTS

Description will be given below with regard to examples of the present invention. In the following descriptions, the case where a sequence of a target gene to be analyzed is determined by the principle of pyrosequencing is taken as an example.

### EXAMPLE 1

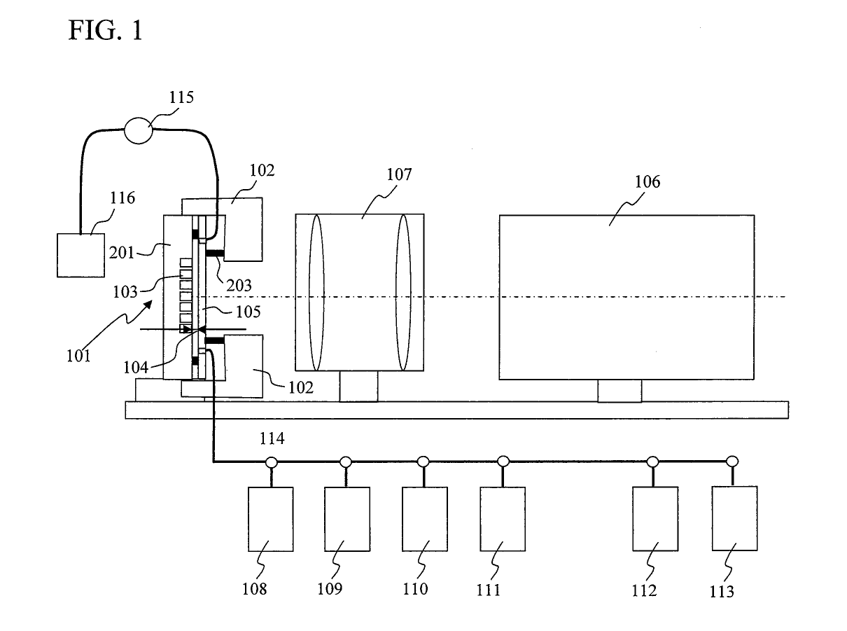

FIG. 1 is a drawing illustrating a configuration example of a chemiluminescence analyzer according to the present invention. In the chemiluminescence analyzer of the present example, various reagents flow through a flow cell 101 formed by a plate 201 having a large number of micro-chambers 103 formed thereon and a transparent substrate 105, and chemiluminescence from each of the large number of micro-chambers formed on the plate 201 is measured to determine a sequence. In the present invention, the thickness of a flow channel for reagents flowing therethrough is changed between the time of chemiluminescence measurement and the time of supply of reagents to the micro-chambers while a reagent is flowing through so that a conductance, a cross-sectional shape, and a cross-sectional area of the flow channel is changed. As a result, at the time of chemiluminescence measurement, while crosstalk among adjacent micro-chambers can be prevented, luminescence intensity can be improved, resulting in improved sensitivity of luminescence measurement. At the time of supply of a reagent to the micro-chambers, and at the time of washing and removal of reaction products, the supply efficiency and the washing efficiency, respectively, can be improved.

In the present example, a driving section 102 is provided for applying a compression force so as to move the transparent substrate 105 closer to the plate 201. Application of the compression force results in a reduction of a flow channel thickness 104, and thereby a chemical substance generated in individual micro-chambers 103 does not go outside of the chambers. As a result, crosstalk is reduced, and the measurement sensitivity is improved. Meanwhile, in the case where a reagent containing an enzyme, such as luciferase, which catalyzes chemiluminescence, is supplied to the micro-chambers 103 before chemiluminescence measurement, the compression force of the driving section 102 is released so as to sufficiently increase the flow channel thickness 104. By this action, necessary reagents can be rapidly supplied to the micro-chambers 103. A detailed structure of the flow cell 101 having a variable thickness of the flow channel will be described later.

The chemiluminescence analyzer of the present example also includes: a two-dimensional imaging device 106, such as a cooled CCD camera, for detecting luminescence images associated with base elongation reactions; a lens system 107 for forming a luminescence image on a two-dimensionally imaging device; reagent tanks 108 to 111 for respectively holding four kinds of nucleic-acid substrates (dATP, dGTP, dCTP, and dTTP) to be sequentially dispensed to the flow cell 101; a washing reagent tank 112 for holding a washing reagent used to wash the inside of the flow cell 101 after measurements of elongation reactions; a conditioning reagent tank 113 for holding a conditioning reagent used to wash away any residual washing reagent component in the cell after the washing; injecting units (a selection valve 114, and a pump 115 for handing the reagents) for injecting the reagents selectively to the flow cell 101; a waste bottle 116; and the like.

The flow channel thickness 104 is increased when the four kinds of nucleic-acid substrates are injected so that the nucleic-acid substrates can rapidly diffuse in the micro-chambers 103. When the individual nucleic-acid substrates are approximately uniformly diffused in the micro-chambers 103 (several seconds after the initiation of the injection of the individual nucleic-acid substrates, for example, 2 seconds later), the transparent substrate 105 is pressed by the driving section 102 so that the flow channel thickness 104 is reduced. In this state, chemiluminescence is measured by an imaging device, and light accumulation is terminated after, for example, 15 seconds. At the same time, the pressing force applied to the transparent substrate 105 is released so as to increase the flow channel thickness 104. By this action, dNTP is additionally supplied, and, thereby, no DNA which has not been elongated is left. Then, in order to remove excess dNTP which is present in the individual micro-chambers 103 before the next base is elongated, apyrase, which is a degrading enzyme of dNTPs, is added to the micro-chambers 103. At this stage, while a thick flow channel is maintained, a washing reagent containing apyrase is caused to flow through the flow channel. In this case, diffusion and flux caused in the thick flow channel can also help excess dNTP to be rapidly discharged. Moreover, if the next nucleic-acid substrate is added to the individual micro-chambers 103 while apyrase is still left therein, the dNTP is degraded by apyrase before completion of the elongation reaction, and the operation proceeds to the next step without completing the elongation reaction. Accordingly, the accuracy of analysis is lowered. To prevent such an event from happening, the conditioning reagent is caused to flow through the flow channel to discharge the apyrase. In this case, the flow channel is also maintained thick so that apyrase can be rapidly discharged by diffusion and flux.

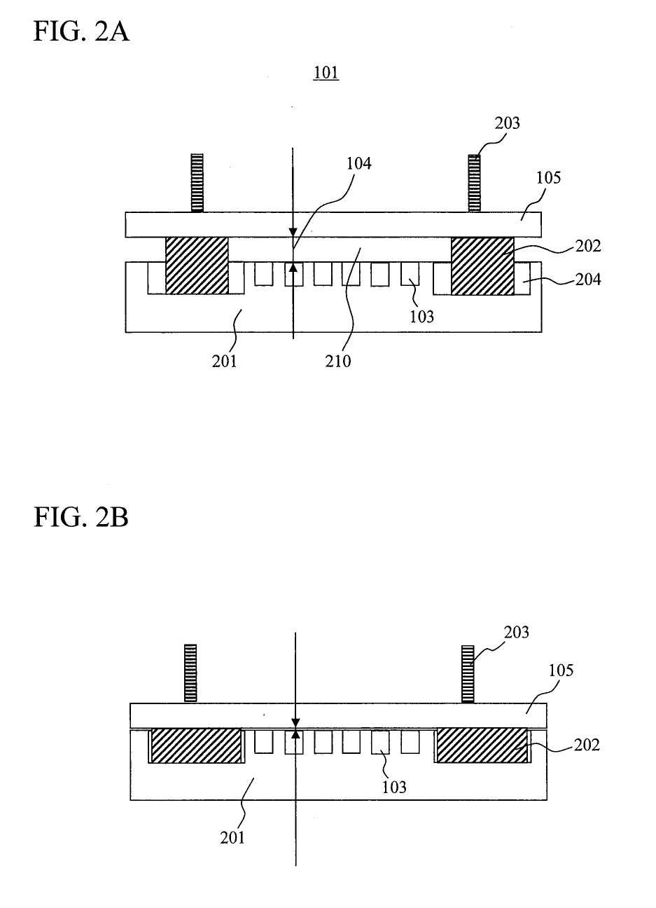

In the following section, a configuration example of the flow cell will be described. FIGS. 2A and 2B are schematic cross-sectional views of the flow cell 101. In the flow cell 101, the plate 201 having a large number of micro-chambers 103 formed thereon and the transparent substrate 105 for measuring chemiluminescence are configured to face each other approximately in parallel, and elastic spacers 202 are provided for allowing reagents to flow without a leakage through a flow channel formed in a distance between the plate 201 and the transparent substrate 105. A region between the plate 201 and the transparent substrate 105 is a reagent flow channel 210, and the thickness 104 of this flow channel 210 can be reduced by pressing the transparent substrate 105 to the plate 201 by use of rods 203 for applying pressure which is fixed to the driving section 102. The driving section 102 may be a step motor a piezoelectric device.

FIG. 2A shows a schematic cross-sectional view illustrating the flow cell having a thick flow channel when no pressure is applied by the rods 203, and FIG. 2B shows a schematic cross-sectional view illustrating the flow cell having a thin flow channel when pressure is applied. In the state illustrated in FIG. 2A, the thickness 104 is set to approximately 0.3 mm so that a reagent can be supplied rapidly and uniformly to the individual micro-chambers 103. On the other hand, in the state illustrated in FIG. 2B, the thickness 104 is set to a few μm or smaller to prevent chemiluminescence substrates (in the present example, PPi and ATP) from diffusing to the outside of the micro-chambers 103. The spacer 202 needs to be formed of a sufficiently elastic and chemically inactive rubber material, and silicone rubber is used in the present example. In addition, cavities 204 are formed on the plate 201 so that the individual spacers 202 can be a thin layer of a few μm or less when the thickness 104 is reduced, more preferably that the flow channel can be completely closed. In such a configuration, even if the compression deformation ratio of the rubber material is low, sufficient changes in the flow channel thickness 104 can be achieved. To be more specific, silicone rubber which can be compressed by 20% at 0.1 MPa and has a thickness of 3 mm, a width of 3 mm, and a circumference of 40 cm is used as the spacers 202, and the depth of the individual cavities 204 is set to 2.4 mm. In this configuration, when the driving section 102 applies a load of 3 kg to each of the four rods 203, the flow channel thickness 104 of a few μm or less can be achieved.

Furthermore, inside of the flow cell 101, it is necessary that substances required for base elongation and chemiluminescence are supplied, and that any reactions other than an intended chemical reaction are inhibited sufficiently. For this reason, resin materials having low reactivity, such as polycarbonate, polypropylene, and polymethylmethacrylate, were adopted as materials for the plate 201 and the transparent substrate 105.

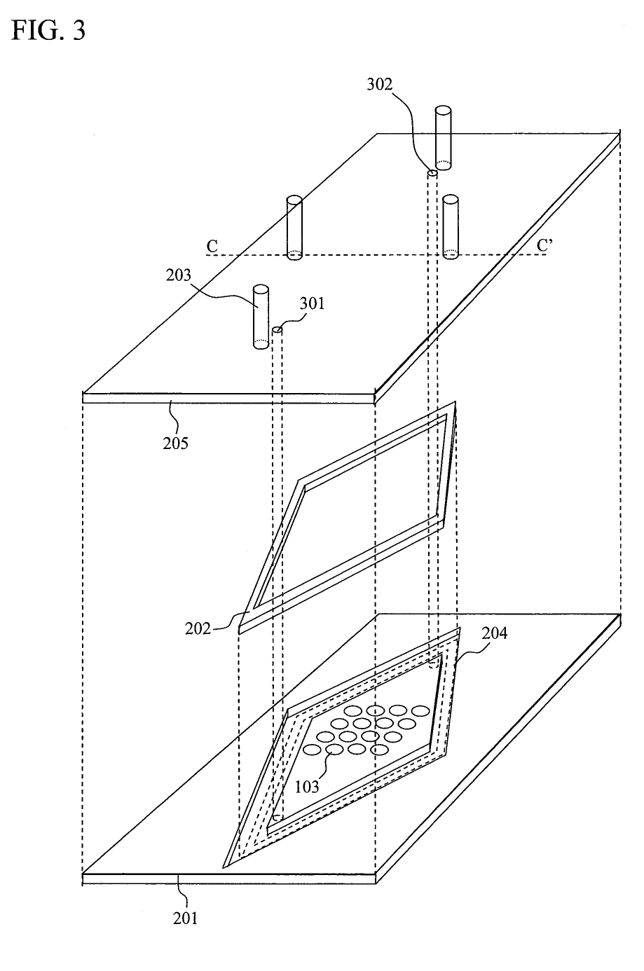

FIG. 3 shows an exploded view of the flow cell 101. FIG. 2 corresponds to a cross-sectional view of FIG. 3 taken along the line C-C′. Reagents are provided from a reagent inlet 301, flowing through a flow channel having a diamond shape in the drawing, supplied to the micro-chambers 103, and discharged from a reagent outlet 302.

The shape of the individual micro-chambers 103 may be, for example, cylindrical. The shape is selected according to the material and production method of the plate 201. The plate 201 having micro-chambers 103 formed thereon may be formed by, for example: a method in which micro-chambers are formed by cutting work on a stainless material; a method in which micro-chambers are formed by masking and wet-etching of a silicon wafer; a method in which micro-chambers are formed by a blaster process using particles on a glass, such as a slide glass; and a method in which micro-chambers are formed on polycarbonate, polypropylene, polyethylene, and the like by injection moulding using a mold. However, materials and production methods of the plate 201 are not limited to these.

Furthermore, although silicone rubber was employed as the elastic spacers 202 in the present example, fluorine-containing rubber, fluoro-rubber, butyl rubber, acrylonitrile butadiene rubber, polychloroprene rubber, ethylene-propylene rubber or the like may also be employed.

In the present example, a sample DNA to be analyzed in the apparatus is fixed on a bead, and measurement is carried out upon confirming that two or more beads do not go in each of the micro-chambers 103. As for a bead material, zirconia, silica, sepharose, various semiconductor materials, various gel materials, and the like may be employed.

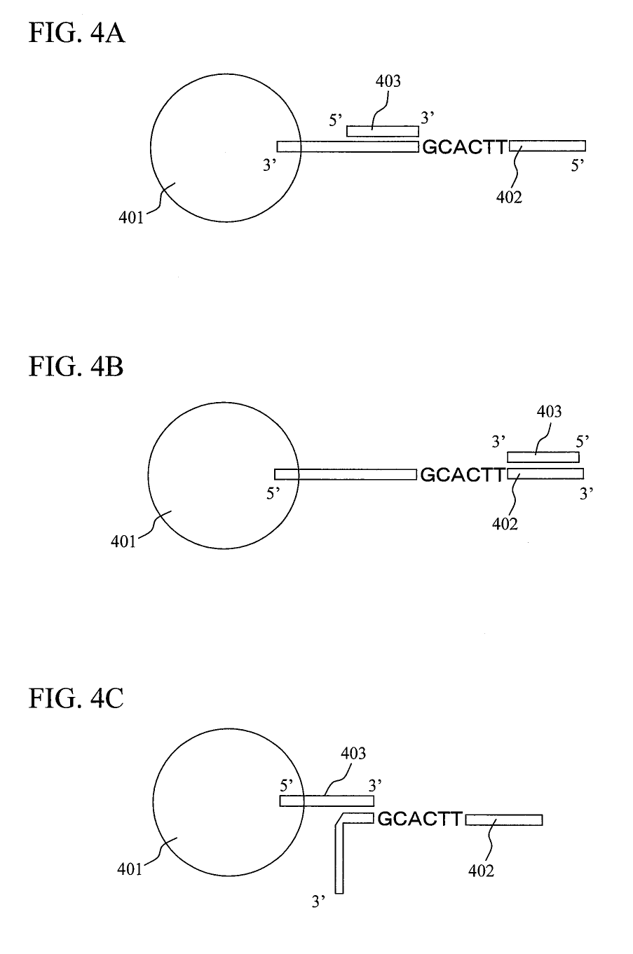

FIG. 4 is a schematic view of a bead having a sample DNA fixed thereon. multiple molecules are fixed onto the surface of a bead 401, each comprising a single-stranded DNA 402 to be analyzed and a primer 403 located at an initiation point for sequence analysis which are complimentarily bonded to each other. It should be noted that only one pair of such molecules is illustrated in FIG. 4 for simplification. In this case, molecules fixed onto the surface of a single bead have to be of one kind, in other words, identical. For amplification of multiple identical molecules on the surface of a single bead, a publicly-known “emulsion PCR” and the like may be adopted (for example, Marguilies et al.). Examples of a method for fixing DNA include: a method, as illustrated in FIGS. 4A and 4B, in which a target DNA to be analyzed is either fixed onto a bead surface, or fixed after being amplified, and then a primer is complementarily bonded to the DNA; and a method, as illustrated in FIG. 4C, in which a primer is fixed onto a bead surface, and then a target DNA to be analyzed is complementarily bonded to the primer.

As for the size of the bead 401, experiments were carried out on those having a diameter approximately from 20 μm to 100 μm, and effects were examined. Variation in the diameter of the bead 401 results in variation in the surface area, and further leads to variation in the number of molecules fixed on the surface of a single bead, in other words, in measurement sensitivity, which will be described later. When a cooled CCD is used as the two-dimensional imaging device 106, measurement can be carried out in all of the above cases. However, the diameter and the depth of the individual micro-chambers 103 in the flow cell 101 should be selected according to the size of beads used. In general, the diameter and the depth of the micro-chambers are preferably set to approximately from 1.2-times to 1.5-times the size of beads used. To be more specific, if beads each having a diameter of approximately 50 μm are used, the diameter and the depth of the individual micro-chambers 103 are preferably set to approximately from 60 μm to 75 μm. This is a preferable condition which can satisfy the requirement that the number of bead fitted into a single micro-chamber is one at the most.

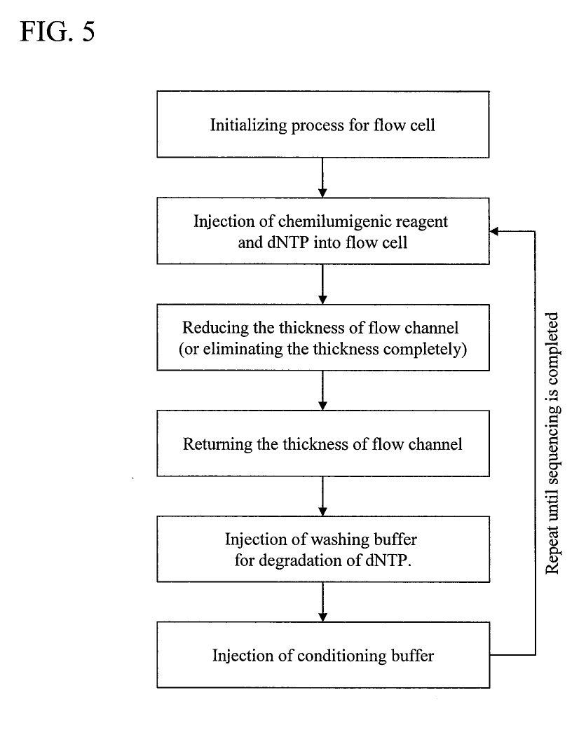

FIG. 5 is a flowchart showing a procedure for the determination of DNA sequences. Firstly, during the initializing process for the flow cell 101, the position of the flow cell 101 is adjusted with respect to the CCD, and the positions and focus of pixels and the micro-chambers 103 in the flow cell 101 are adjusted, while preparations for DNA elongation reactions and associated luminescence measurement are carried out by, for example, washing the flow cell 101. Next, a chemilumigenic reagent containing any one of the nucleic-acid substrates, dATP, dCTP, dGTP and dTTP, is caused to flow in the flow cell for approximately 2 seconds to supply any one of these substances to the individual micro-chambers 103. Thereafter, the spacer 202 is compressed by driving the driving section 102 to reduce the flow channel thickness 104 or to completely shut off the flow channel. Such a state is maintained for 15 seconds while a luminescence image is being captured by the CCD.

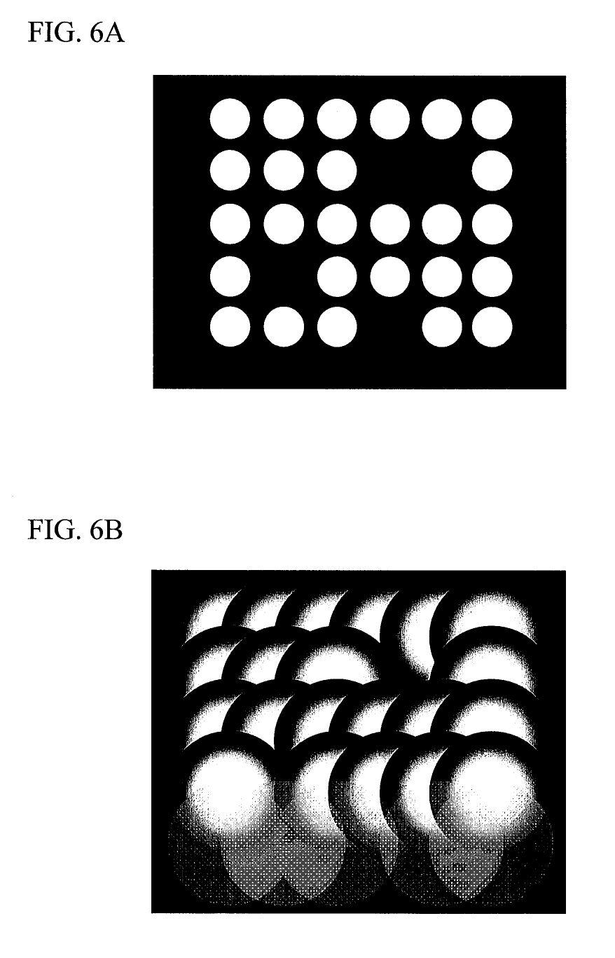

A schematic view of a luminescence image thus obtained is shown in FIG. 6A. As shown in the drawing, it is possible to measure luminescence from the individual micro-chambers separately. On the other hand, FIG. 6B shows a schematic view of a luminescence image obtained without narrowing the flow channel. Since there are components, such as PPi and ATP, which produce luminescence after diffusing out of the individual micro-chambers 103, luminescence from the individual micro-chambers 103 cannot be measured separately and this results in an almost uniform luminescence image. In other words, adjacent micro-chambers 103 can hardly be separated due to crosstalk.

Referring back to FIG. 5, in the next step, in order to complete the elongation reaction, the thickness of the flow-cell thickness 104 is increased back to the original state, which is 0.3 mm, and maintained for 15 seconds, a washing buffer containing apyrase is caused to flow in the flow cell 101 for 30 seconds, then a conditioning buffer is caused to flow for removal of apyrase so as to cause the next base elongation and chemiluminescence to take place efficiently, and a chemilumigenic reagent containing the next dNTP is caused to flow in the flow cell 101. This process is repeated until the sequencing is completed. Along with this reagent supply operation, image data are accumulated, and the target sequence to be analyzed can be determined by examining which micro-chambers produced luminescence for each of the dNTPs, and the intensity of the luminescence.

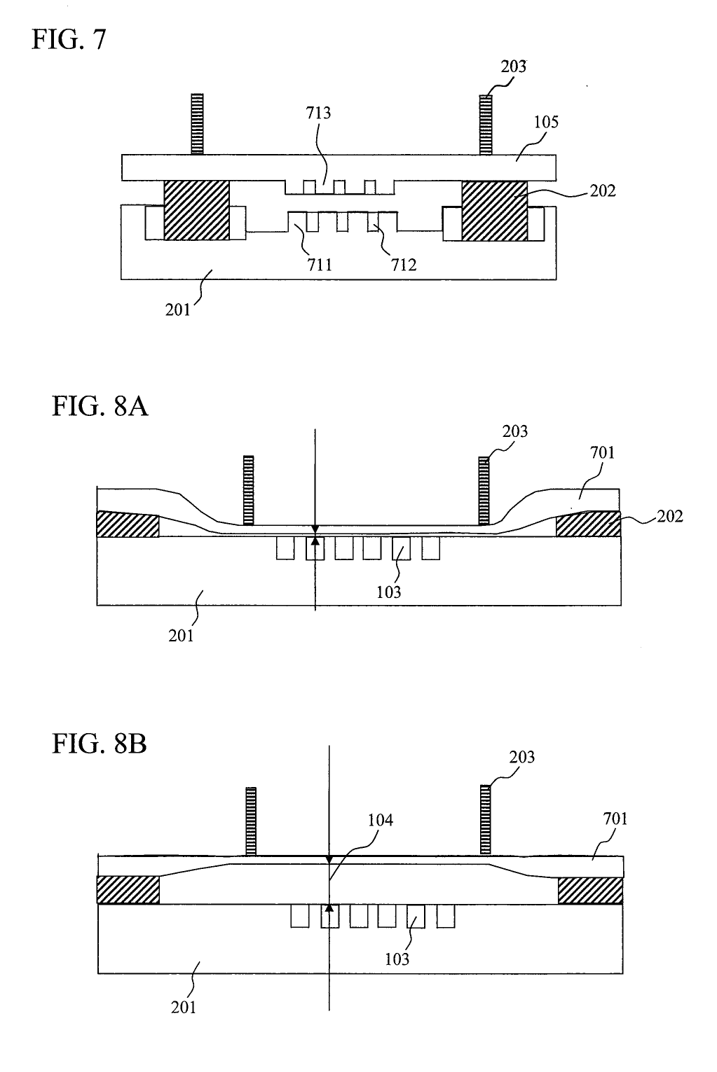

FIG. 7 shows a schematic cross-sectional view of another example of the flow cell. In the above example, each of the micro-chambers 103 is a concave portion formed by either cutting work or injection moulding on the plate 201. In this case, however, a convex portion 711 is formed on the plate 201 by the same processing method, and non-through holes 712 formed in the convex portion 711 are used as micro-chambers. If the depth of the individual micro-chambers is large, diffusion of reactive substrates dNTPs and discharge of reaction products take longer time. For this reason, a convex portion 713 is also formed on the transparent substrate 105 so that movement of the individual beads can be restrained by two holes provided on the convex portions 711 and 713, respectively. In this configuration, the depth of the individual non-through holes 712 can be smaller than the depth of the individual micro-chambers 103 illustrated in FIG. 2. Accordingly, a diffusion distance required for supply of reactive substrates can be shortened, and, at the same time, the volume of the individual micro-chambers can be increased. Therefore, it is also possible to prevent that substrates required for elongation reactions become short, and the accuracy of the sequencing analysis is lowered as a result.

In addition, although a target DNA to be analyzed was fixed to a bead, and the bead was inserted into a micro-chamber so as to fix the target DNA to be analyzed to the micro-chamber, it is not necessarily a bead to be used for fixing DNA. As a method for fixing a target reactant to be analyzed, for example, a method for fixing a reactant to the inner wall of the individual micro-chambers by chemical bond, or a method for fixing by magnetic attraction with a magnetic bead may be adopted.

### EXAMPLE 2

In Example 1, the flow channel thickness 104 was changed by causing elastic deformation of the spacers 202 so that diffusion of products from the micro-chambers 103 was inhibited. The present example is configured to achieve the same effect as in Example 1 by deforming a transparent substrate, serving as an upper plate of a flow cell, to change the thickness of the flow channel located immediately above the micro-chambers.

FIGS. 8A and 8B show schematic cross-sectional views of another example of the flow cell 101. In the flow cell 101 of the present example, it is configured that the flow channel thickness 104 can be reduced immediately above the micro-chambers 103 by bending the transparent substrate 701 with application of stress. FIG. 8A is a view illustrating a state when stress is not applied, while FIG. 8B is a view illustrating a state when stress is applied to reduce the flow channel thickness 104. In the present example, a part of the transparent substrate 701 serving as an upper plate is formed as a thin film so that the transparent substrate 701 can be easily deformed when stress is applied with the rods 203. As for a material of the transparent substrate 701, although polycarbonate was used, other transparent resin materials may be used. In particular, a part of the transparent substrate 701 corresponding to the region where the micro-chambers 103 are located is formed as a thin film so that the flow channel thickness 104 can be uniform throughout the region where the micro-chambers 103 are located when stress is applied. As an example, the thickness of the transparent substrate 701 was formed to 3 mm in a thick part, and approximately 1 mm in a part formed as a thin film. The diameter and the depth of the micro-chambers 103 were both set to 10 μm. A zirconia bead having a diameter of 8 μm on which a target DNA to be analyzed is fixed is inserted into the individual micro-chambers 103, and measurement was performed. The micro-chambers 103 were arranged in a 4096×4096 format in a region of 6.144 cm×6.144 cm so that the center of the individual micro-chambers 103 is located at the intersecting point of 15 μm×15 μm grids.

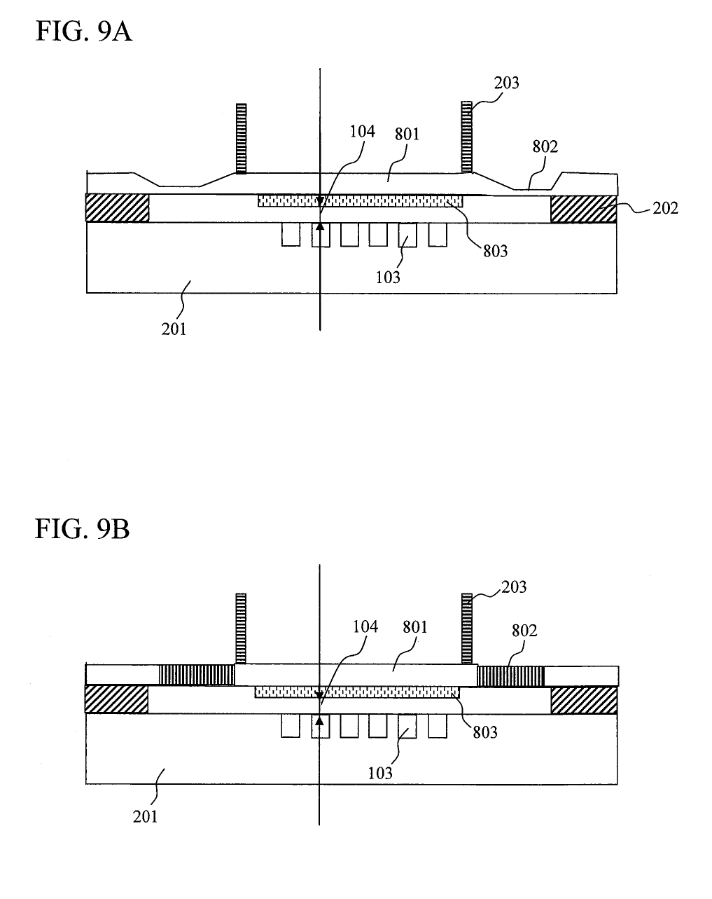

In other configurations for deformation of the transparent substrate, a peripheral part 802 of a region corresponding to the micro-chambers 103 may be formed as a thin film, as shown in FIG. 9A, or a the peripheral part 802 of the region corresponding to the micro-chambers 103 may be made of highly-elastic silicone rubber and the like, as shown in FIG. 9B. As an example, in the case, as shown in FIG. 9A, where the peripheral part 802 is formed as a thin film, the thickness in a region 801 where the micro-chambers 103 are located was set to 3 mm, while the thickness of the peripheral part 802 was set to 0.5 mm. In the case, as shown in FIG. 9B, where the peripheral part 802 is alternatively made of a highly-elastic material, silicone rubber having a width of 10 mm and a thickness of 3 mm was fixedly attached to the plate 201 by heat sealing. Instead of heat sealing, attachment by use of an adhesive agent may be adopted.

In such a configuration, the rigidity of the transparent substrate in the region 801 where the micro-chambers 103 are located is high. Accordingly, it is possible to achieve a high deformation rate in the region 801 while maintaining the contact with the plate. As a result, the flow channel thickness 104 can be uniformly reduced even if a region where the micro-chambers 103 are located on the plate is as large as a few centimeters square. Moreover, in order to more effectively prevent diffusion of reaction products from the micro-chambers 103 even when the mechanical uniformity of the flow channel thickness 104 is not high, in other words, the upper plate is distorted, unlevel, or arranged at a slant, an adhesion layer 803 may be formed by attaching highly-elastic silicone rubber onto the transparent substrate 801 on the side corresponding the micro-chambers 103. In such a case, the thickness of the spacer 202 is set to 0.5 mm, and the thickness of the adhesion layer 803 is set to 0.2 mm, when no force is applied. In this configuration, the flow channel thickness 104 can be alternately set to 0.3 mm and 0.1 μm or less in a repeated manner.

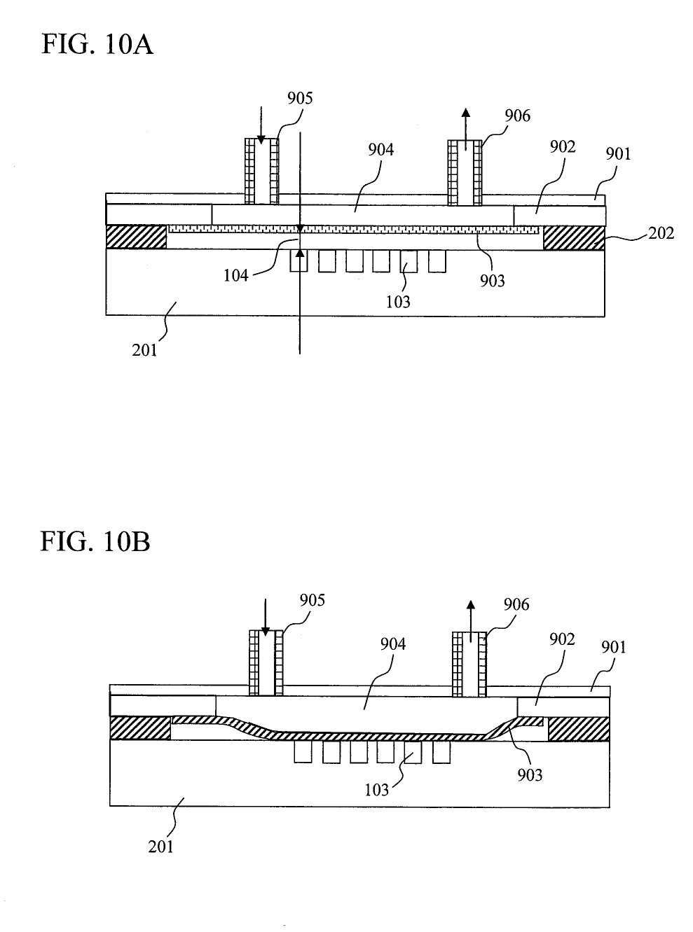

The driving force for deformation in the above example is mechanical pressure by the driving section 102. However, driving force for deformation may be pressure of gas or liquid. FIGS. 10A and B show an example in which such a configuration is adopted. FIG. 10A illustrates a state in which the flow channel thickness 104 is large with no pressure applied, while FIG. 10B illustrates a state in which the flow channel thickness 104 is small with pressure applied. In the present example, a three-layered structure is employed so as to form a hollow transparent substrate. To be more specific, an upper layer 901, a spacer layer 902, and a deformation layer 903 are attached together to form a transparent substrate having a hollow region 904 between the upper layer 901 and the deformation layer 903.

Injecting air from a pressure-applying port 905 causes the deformation layer 903 to deform, and the flow channel thickness 104 to be decreased in the region where the micro-chambers 103 are located. Meanwhile, releasing air from a pressure-releasing port 906 causes the flow channel thickness 104 to be increased. Repetition of these operations makes it possible to sequentially perform prevention of diffusion from the micro-chambers 103 and efficient supply of luminescence reagents. As an example, an acrylic plate having a thickness of 3 mm was used as both the upper plate 901 and the spacer layer 902 of the transparent substrate. A transparent polypropylene film having a thickness of 0.5 mm was used as the deformation layer 903.

As for the deformation layer 903, soft materials, such as silicone rubber, may be used. However, in such a case, there may arise a problem involved in the uniformity of the flow channel thickness 104. In order to increase the uniformity of the flow channel thickness 104, same as in the above example, combination use of materials may be allowed as follows. The deformation layer 903 may be made of a thick material in a region corresponding to the micro-chambers 103, and made of a thin material in the peripheral part so as to be easily deformed, or the deformation layer 903 may be made of a hard transparent material in the region corresponding to the micro-chambers 103, and made of a material, such as silicone rubber, which can be easily elastically deformed, in the peripheral part. It is also the same as described above that an adhesion layer may be attached so as to increase the attachment between the deformation layer 903 and the plate 201. In this example, air for deforming the deformation layer 903 is applied from the pressure-applying port 905. However, instead of air, other transparent and inactive liquids, such as water and oil, may be used. The flow channel thickness 104 can be alternately set to 0.3 mm and 0.1 μm or less in a repeated manner in such a case as well.

### EXAMPLE 3

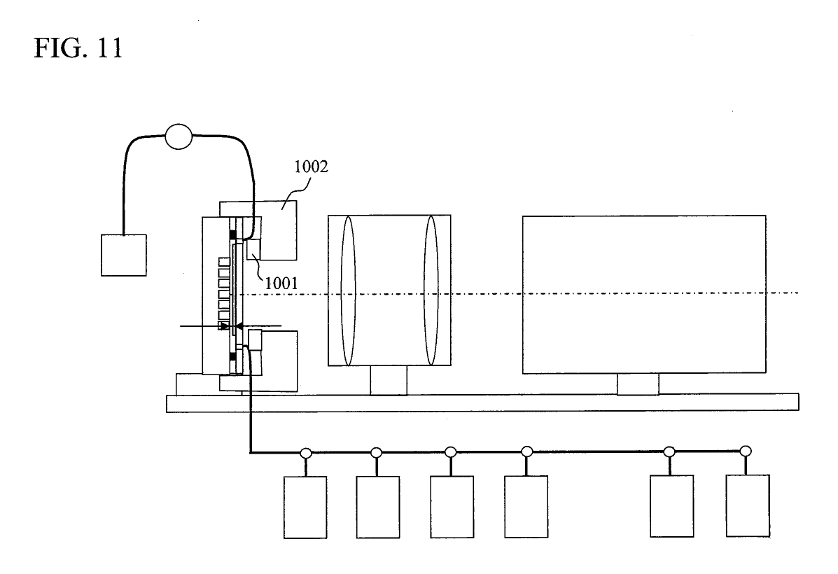

Instead of moving and deforming the transparent substrate and the plate 201, another transparent substrate is provided in the flow channel in the flow cell so as to prevent the diffusion of products from the micro-chambers 103. FIG. 11 shows a system configuration example of the chemiluminescence analyzer. In the place of the rods 203 and the driving section 102 in FIG. 1, electromagnets 1001 and a driving section 102 for supporting and driving the electromagnets 1001 are respectively provided.

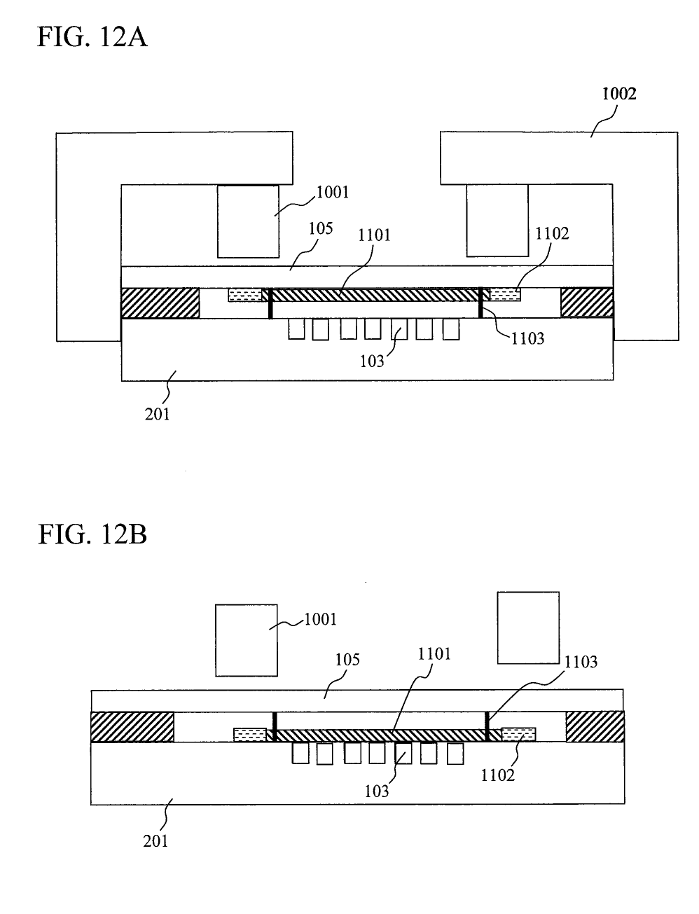

FIG. 12A shows a schematic cross-sectional view of a state where the flow channel thickness of the flow cell has been increased, and FIG. 12B shows a schematic cross-sectional view of a state where the flow channel thickness has been reduced. In a configuration where a transparent substrate 1101 made of polypropylene is provided in the flow channel, and neodymium magnets 1102 (main components: neodymium, iron, and boron) are each covered on the surface with polypropylene having a thickness of approximately 0.2 mm, and then fixed on to the transparent substrate 1101, either the state illustrated in FIG. 12A or the state illustrated in FIG. 12B is achieved by changing the polarity of the electromagnets 1001. In addition, in order to cause the transparent substrate 1101 to move only in a direction of the flow channel thickness, guide pins 1103 are provided through respective holes provided on the transparent substrate 1101. The guide pins 1103 each having a diameter of 1 mm are made of polypropylene, and are fixed either to the plate 201 or an upper transparent substrate 105. The permanent magnet 1102 may be a samarium-cobalt magnet (main components: samarium, cobalt, copper, and iron), an alnico magnet (main components: aluminum, cobalt, and nickel), a ferrite magnet (main components: ferric oxide, barium, and strontium) or the like. In the driving section 1002, the polarity of the magnet is changed according to the polarity of a current applied to the electro magnets 1001. However, a direction of magnetic force applied to the permanent magnet 1102 may be changed by rotating the electromagnets 1001.

When the transparent substrate 1101 is moved vertically so that the transparent substrate 1101 can be closer to the upper transparent substrate 105, a reagent is supplied to the micro-chambers 103. On the other hand, the transparent substrate 1101 is moved so that the transparent substrate 1101 can be closer to the plate 201, measurement is performed without causing crosstalk with diffusion of products from the micro-chambers 103 inhibited. By these actions, it is possible to achieve two states, 0.3 mm and 1 μm, of the effective flow channel thickness in the region where the micro-chambers 103 are located.

As another method for changing the flow channel thickness by using a transparent substrate provided in the flow channel, there is a method in which the thickness of a transparent substrate having a hollow part in the center is changed by applying pressure with air or a solution, such as water, to the hollow part.

### EXAMPLE 4

While both inhibition of the diffusion from the micro-chambers 103 and rapid supply of reagents are achieved in the above example by the moving of the transparent substrate 1101 provided in the flow channel in a direction of the flow channel thickness (in a vertical direction), these are achieved in the present example by the opening and closing of inlets to the respective micro chambers.

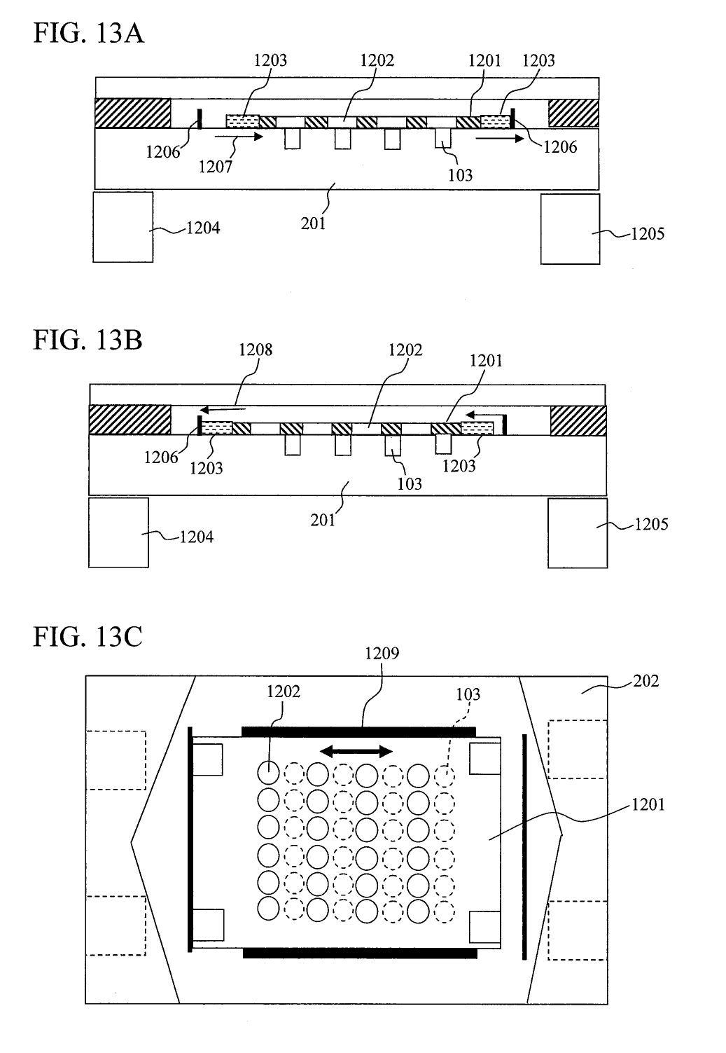

FIGS. 13A and 13B each show a schematic cross-sectional view of a flow cell. FIG. 13A illustrates a state in which inlets to the respective micro-chambers are open, while FIG. 13B illustrates a state in which these inlets are closed. In a polypropylene transparent substrate 1201 provided in the flow channel, multiple through holes 1202 are formed in accordance with the size and alignment of the micro-chambers 103. The micro-chambers 103 are opened or closed by movement of the transparent substrate 1201 along the surface of the plate 201. When the transparent substrate 1201 is moved so as to match the position of the through holes 1202 in the transparent substrate 1201 to the position of the micro-chambers 103, the respective micro-chambers 103 are open without covering, and therefore reagents, such as bases, are sufficiently supplied to the DNA on the beads inserted inside of the respective micro-chambers 103. Conversely, when the transparent substrate 1201 is moved so as not to locate the through holes 1202 above the respective micro-chambers 103, the micro-chambers 103 are each covered, and, as a result, chemical substances produced in reactions are inhibited from diffusing to the outside of the micro-chambers 103.

The transparent substrate 1201 was moved by application of magnetic force from electromagnets 1204 and 1205 to a permanent magnet 1203 fixed in an edge region of the transparent substrate 1201. For example, for opening the inlets of the respective micro-chambers 103, a magnetic field direction in a region where the permanent magnets 1203 are located is set to a direction indicated by an arrow 1207 so that the transparent substrate 1201 is pressed to a right side stopper 1206. Thus, the through holes 1202 are located above the respective micro-chambers 103. For closing the inlets of the micro-chambers 103, the transparent substrate 1201 is moved so as to be pressed to an opposite stopper 1206 by setting the magnetic field direction to the opposite direction indicated by an arrow 1208, and thereby the through holes 1202 are displaced from above the micro-chambers 103. The magnetic field direction can be changed from the direction indicated by the arrow 1207 to that by the arrow 1208. The change is achieved by reversing the polarities of the electromagnets 1204 and 1205 from a state in which the north pole of the electromagnet 1204 is located in the upper part of the drawing and the north pole of the electro magnet 1205 is located in the lower part of the drawing. In addition, in order to prevent the transparent substrate 1201 from detaching from the plate 201, and to prevent the through holes 1202 from being displaced relative to the micro-chambers 103, guide rails 1209 are provided along the respective sides of the transparent substrate 1201 as shown in FIG. 13C. As a result, the micro-chambers 103 can be opened and closed by moving the transparent substrate 1201 from side to side by 15 μm while maintaining the distance between the plate 201 and the transparent substrate 1201 of 1 μm or less.

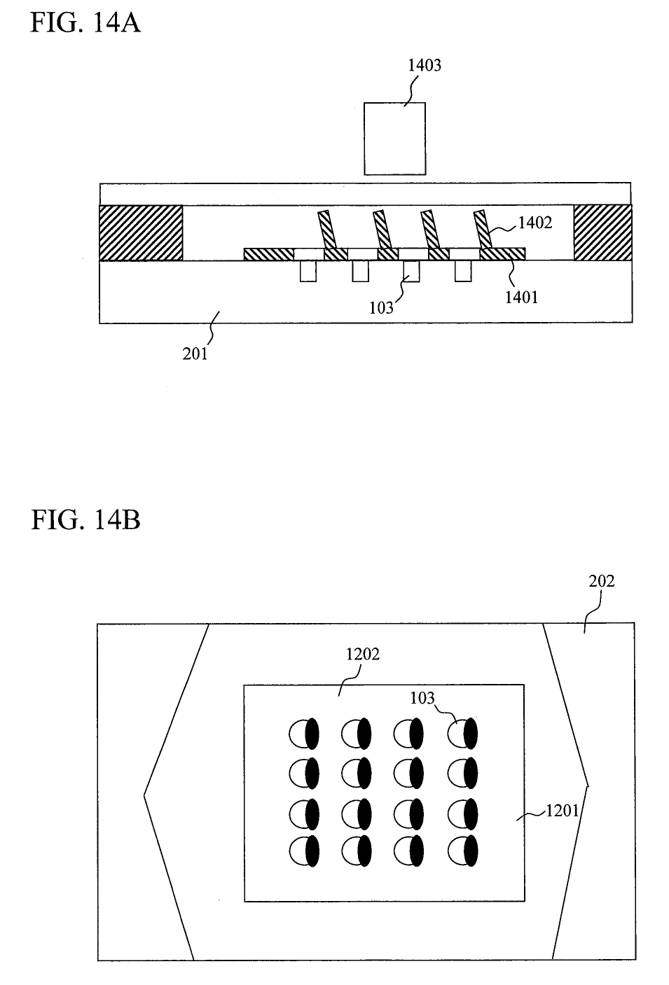

FIG. 14 shows a schematic view of a flow cell provided with other measures for opening and closing of the micro-chambers 103. A substrate 1401 made of a soft material, such as silicone rubber, and provided with valves 1402 at positions corresponding to the micro-chambers 103 is prepared, and the substrate 1401 is fixed on the surface of the plate 201. Opening and closing the valves 1402 by magnetic force makes it possible to achieve both prevention of diffusion of chemical substances produced in the micro-chambers 103 and rapid supply of reagents to the micro-chambers 103. For the preparation of the substrate 1401, circular incisions are made on silicone rubber by pressing at positions corresponding to the opening portions of the micro-chambers 103. In the preparation, however, no incision is made at positions serving as hinges of the respective valves 1402. Meanwhile, a transparent magnetic body prepared by grinding a material made of ZnO doped with Mn into beads having a diameter of a few Am or less is mixed with silicone rubber and then molded so as to magnetize the valves 1402. When an electric current is applied to the electromagnet 1403 in a certain direction, the valves 1402 are attracted upward and opened. When an electric current is applied in the opposite direction, the valves 1402 are closed. In such a configuration, both rapid supply of reagents and inhibition of diffusion of products of reactions are achieved.

### EXAMPLE 5

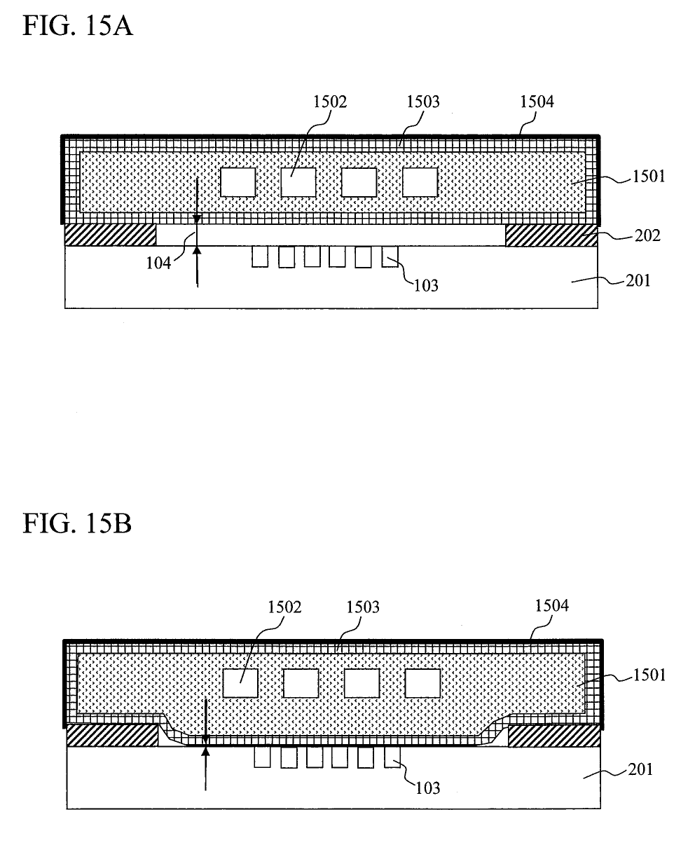

In the present example, a gel capable of volume change is employed for changing the flow channel thickness 104 of a flow cell. FIGS. 15A and 15B each show a schematic cross-sectional view of the flow cell. FIG. 15A illustrates a state in which the flow channel thickness 104 is large, and FIG. 15B illustrate a state in which the flow channel thickness 104 is small.

In the present example, a transparent substrate 1501 which faces the plate 210 having the micro-chambers 103 formed thereon is made of a gel capable of volume expansion. As a gel, acrylamide gel can be employed. When either the temperature is lowered or the concentration of acetone in an acetone solution used as a gel solvent is increased, this gel undergoes volume phase transition in which the volume of the gel is rapidly expanded at a certain temperature or at a certain acetone concentration. In the present example, the flow channel thickness 104 is changed by use of such a volume expansion of gel. In the present example, the transparent substrate 1501 is mostly composed of acrylamide gel in an acetone solution. The gel is covered by a thin transparent film 1503 having a thickness of approximately 0.5 mm made of polypropylene and the like so that the acetone solution solvent will not be mixed with reagents flowing through the flow channel. The film 1503 may also be made of a flexible resin material, such as polyvinylchloride. In the meantime, since the volume of the gel expands almost isotropically, a guide layer 1504 made of transparent polycarbonate is formed on the transparent substrate 1501 on the upper surface thereof, which is located at the other side of the flow channel, and on the side surfaces thereof, to prevent deformation of these surfaces other than the surface on the flow channel side so that the flow channel thickness 104 can be effectively changed by gel expansion. In such a configuration, a planar shape of the gel in the region in which the micro-chambers 103 are located is maintained. This can prevent distortion of a luminescence image obtained from the micro-chambers 103 and defocusing due to the lens effect when the volume is repeatedly changed.

In order to uniformly and rapidly change the acetone concentration in the gel contained in the transparent substrate 1501, flow channels 1502 in which an acetone solution flows are provided. Since small molecules, such as acetone, can pass through gel, these flow channels are not necessarily needed when the transparent substrate 1501 is not very large. When the spacers 202 for determining the flow channel thickness when reagents are supplied to the micro-chambers 103 each have a thickness of 1 mm, the flow channel thickness can be almost 0 by volume expansion of the gel. An acetone solution is supplied from the flow channels 1502 so that the concentration of the acetone in the acetone solution is 20% or less in the case where the flow channel thickness is to be increased, while the concentration is 60% or above in the case where the flow channel thickness is to be reduced and then the flow channel is to be completely closed.

As a gel material other than acrylamide gel, isopropylacrylamide gel may be employed. In the case where a gel made of a copolymer of methacryloyl amino propyl trimethyl ammonium chloride (MAPTAC) and acrylic acid at a ratio of 7:12 is used in the transparent substrate 1501 in FIGS. 15A and 15B, volume expansion can be achieved by changing pH from 7 to 9. In order to change pH, two kinds of buffers having different pH are alternately caused to flow from the flow channels 1502 so that the flow channel thickness 104 was alternately changed. It is also possible to change the gel volume by changing not pH but ionic strength.

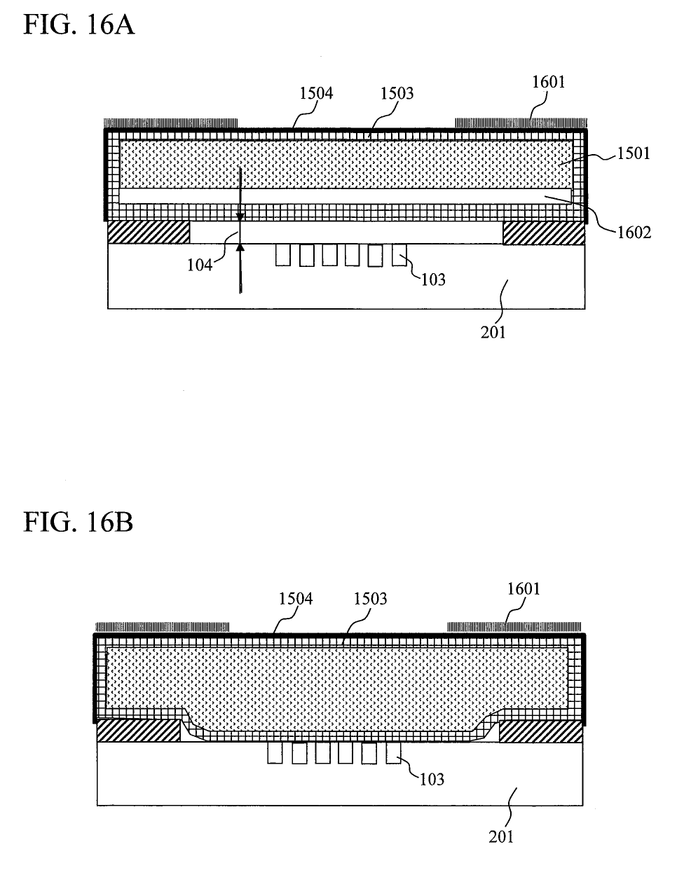

An example of a flow cell in which the volume of gel is changed by changing the temperature of the gel so as to change the flow channel thickness 104 is illustrated in schematic cross-sectional views in FIGS. 16A and 16B. FIG. 16A illustrates a state in which the flow channel thickness 104 has been increased, and FIG. 16B illustrates a state in which the flow channel thickness 104 has been reduced.

In a state in which the concentration of acetone solution is set to approximately 60% or higher with acrylamide gel as a gel material, the temperature of the gel in the transparent substrate 1501 is changed from 40° C. to 20° C. so as to go through the critical temperature of 30° C. For causing the temperature change, Peltier devices (electron cooling devices) 1601 are arranged. The Peltier devices 1601 are arranged at the edge of the transparent substrate 1501 so that they do not interfere with luminescence analysis. In addition, in order to control the temperature of the gel and the temperature of reagents flowing through the flow channel independently, an air layer 1602 serving as an adiabatic region is provided between the gel and the polypropylene film 1503.

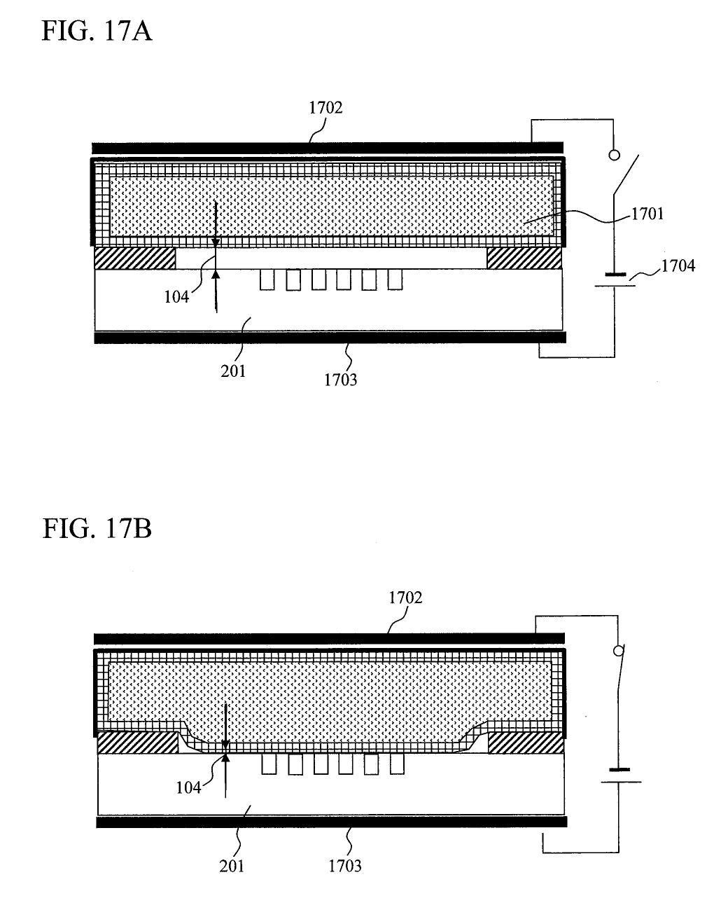

It is also possible to change the flow channel thickness 104 by causing volume change with application of an electric field. A schematic cross-sectional view of a flow cell in such a case is shown in FIGS. 17A and 17B. FIG. 17A illustrates a state in which the flow channel thickness 104 has been increased, and FIG. 17B illustrates a state in which the flow channel thickness 104 has been reduced.

As a gel, partially-hydrolyzed acrylamide gel was used. To be more specific, gel was prepared by radical polymerization of acrylamide gel and N, N′-methylene-bis-acrylamide, and the gel thus obtained was hydrolyzed in a 1.2% solution of N,N,N′,N′-tetramethylenediamine for more than one month to obtain polymeric gel in which approximately 20% of acrylamide groups are substituted by acrylic acid. The polymeric gel thus obtained was used as a transparent substrate gel 1701. A transparent electrode was used for an electrode 1702 on the side where chemiluminescence is measured, while a platinum electrode was used for an electrode 1703 on the other side. The thickness of the plate 201 was set to approximately 5 mm so that the flow-pass thickness 104 can be sufficiently varied by applying from an electric source 1704 a voltage of approximately 1 V to a portion between the electrodes 1702 and 1703. In addition, a resin material (polypropylene or the like), not a metal material, was used as a material of the plate 201 so as to avoid screening of the electric field.

### EXAMPLE 6

In the case where, especially, the micro-chambers are completely closed so as to prevent reaction products from diffusing, supply of reactive substrates required for reactions from outside is stopped. Such a case sometimes results in insufficient elongation of DNA due to shortage of dNTPs serving as reactive substrate. A configuration example of the micro-chambers for preventing such an event from occurring will be described below.

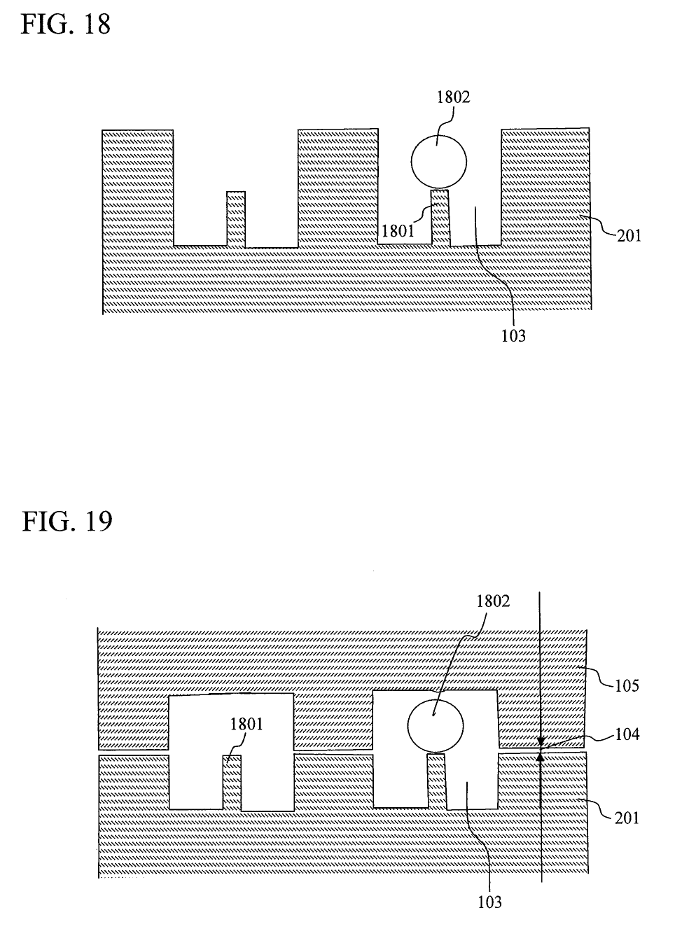

FIG. 18 shows a schematic cross-sectional drawing of a flow cell in the present example. A post 1802 was provided in the individual micro-chambers 103 so that a bead 1802 to which DNA is fixed on the surface can be held floating in the individual micro-chambers 103. Having such a configuration, it is possible to increase the volume of a reagent containing dNTP in the individual micro-chambers 103 compared to the case with no post provided. Accordingly, incomplete elongation of DNA can be prevented. Moreover, in a cylindrical micro-chamber, the concentration of dNTP is highly likely to be lowered on the bead surface located closer to the bottom of the chamber. However, providing the post 1801 allows such a part having a low dNTP concentration to be located away from the bead surface. For this reason as well, the likelihood of having incomplete elongation of DNA can be reduced.

Meanwhile, it is necessary not only to prevent incomplete elongation of DNA, but also to improve the efficiency of buffer exchange so that no residual dNTP from the previous reaction exists in the next dNTP reaction when dNTPs are sequentially added to the micro-chambers for elongation reactions. A cross-sectional structure of a flow cell in which such an objective can be effectively achieved is shown in a schematic drawing in FIG. 19.

In this example, not only the plate 201 has concave portions formed thereon corresponding the micro-chambers 103 but also the transparent substrate 105 has concave portions formed thereon. FIG. 19 illustrates a state in which the flow channel thickness 104 has been reduced. Even in this state, each of the micro-chambers 103 has a solution volume large enough to contain a reactive substrate. On the other hand, when the flow channel thickness 104 is increased so as to supply a reactive substrate to the individual micro-chambers 103, particularly to DNA fixed on the bead 1802, the substrate can be rapidly supplied because the individual micro-chambers 103 are shallow. Furthermore, vice versa, the substrate can be rapidly discharged. In other words, the buffer exchange efficiency is high. It should be noted that the transparent substrate 105 has to move up and down so that the concave portions on the transparent substrate 105 match the respective concave portions on the plate 201.

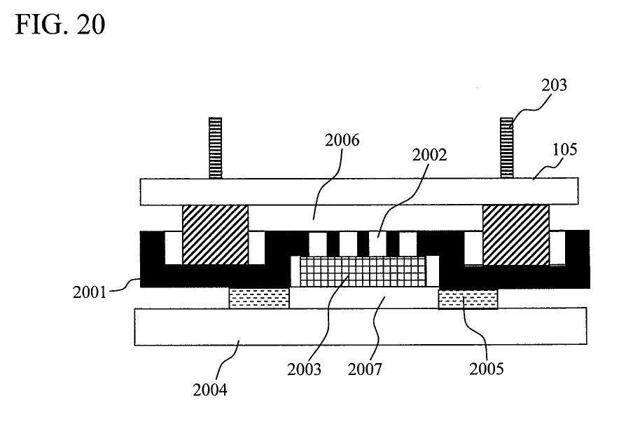

Furthermore, the structure of another flow cell in which efficiency of DNA elongation reaction and buffer exchange efficiency are improved is illustrated in the schematic cross-sectional view in FIG. 20. In this example, micro-chambers 2002 are formed as through holes provided in a substrate 2001. On the bottom of these through holes, a gel layer 2003 made of acrylamide or the like which allows reactive substrates go through is arranged. Accordingly, even when the inlets located on top of the micro-chambers 2002 are closed, dNTPs can be supplied through the gel layer 2003 which allows reactive substrates go through. As a result, the structure prevents incomplete elongation of DNA. For discharge of dNTP, the transparent substrate 105 is elevated so as to increase the thickness of a flow channel 2006, and then a washing buffer is caused to flow from the side of a lower flow channel 2007. As a result, excess dNTP can be rapidly removed from the micro-chambers 2002. The lower flow channel 2007 is formed between the substrate 2001 having through holes and a substrate 2004 arranged in approximately parallel to the substrate 2001. The thickness of the lower flow channel 2007 can be set, for example, to 1 mm by use of spacers 2005.

### EXPLANATION OF REFERENCE NUMERALS

101 . . . Flowcell
102 . . . Driving section
103 . . . Micro-chamber
105 . . . Transparent substrate
106 . . . Two-dimensional imaging device
107 . . . Lens system
201 . . . Plate
202 . . . Spacer
203 . . . Rod
210 . . . Reagent flow channel
401 . . . Bead
402 . . . Single-stranded DNA
403 . . . Primer
701 . . . Transparent substrate
711 . . . Convex portion
712 . . . Non-through hole
713 . . . Convex portion
803 . . . Adhesion layer
901 . . . Upper layer
902 . . . Spacer layer
903 . . . Deformation layer
905 . . . Pressure-applying port
906 . . . Pressure-releasing port
1001 . . . Electromagnet
1002 . . . Driving section
1101 . . . Transparent substrate
1102 . . . Permanent magnet
1103 . . . Guide pin
1201 . . . Transparent substrate
1202 . . . Through hole
1203 . . . Permanent magnet
1206 . . . Stopper
1209 . . . Guide rail
1401 . . . Substrate
1402 . . . Valve
1403 . . . Electromagnet
1501 . . . Transparent substrate
1502 . . . Flow channel
1503 . . . Film
1504 . . . Guide layer
1601 . . . Peltier Device
1602 . . . Air layer
1701 . . . Gel
1702 . . . Electrode
1703 . . . Electrode
1704 . . . Power supply source
1801 . . . Post
1802 . . . Bead
2001 . . . Substrate
2002 . . . Micro-chamber
2003 . . . Gel layer
2004 . . . Substrate
2005 . . . Spacer
2006 . . . Flow channel
2007 . . . Lower flow channel

What is claimed is:

1. A chemiluminescence analyzer, comprising:
a plate having a plurality of chambers formed thereon;
a transparent substrate arranged to face the plate, the transparent substrate and the plate forming a flow channel in between;
an injecting unit for selectively injecting a reactive substrate and a washing buffer to the flow channel;
an imaging system for taking an image, through the transparent substrate, of luminescence due to a chemical reaction between a reactant held in each of the plurality of chambers formed on the plate and the reactive substrate supplied through the flow channel; and
a flow channel control means for changing any one of conductance of the flow channel and a cross-sectional shape of the flow channel.

2. The chemiluminescence analyzer according to claim 1, wherein
the flow channel control means is a means for changing the distance between the plate and the transparent substrate, and
the distance is increased when any one of the reactive substrate and the washing buffer is injected to the flow channel, and
the distance is reduced when an image is taken by the imaging system.

3. The chemiluminescence analyzer according to claim 2, wherein the flow channel control means sets the distance to substantially zero when an image is taken by the imaging system.

4. The chemiluminescence analyzer according to claim 2, wherein
the plurality of chambers are surrounded by elastic spacers arranged between the plate and the transparent substrate, and
the flow channel control means reduces the distance by compressing the spacers by application of a pressing force to the transparent substrate.

5. The chemiluminescence analyzer according to claim 1, wherein
the transparent substrate is deformable, and,
by controlling stress applied to the transparent substrate, the flow channel control means increases a distance between the plate and a part of the transparent substrate when any one of the reactive substrate and the washing buffer is injected to the flow channel, and the flow channel control means reduces the distance when an image is taken by the imaging system, the part of the transparent substrate corresponding to a region in which the plurality of chambers are formed on the plate.

6. The chemiluminescence analyzer according to claim 1, wherein
the transparent substrate includes a hollow compartment and a transparent film being in contact with the flow channel, and,
by introducing and discharging a fluid to and from the hollow compartment, the flow channel control means moves the transparent film away from a surface of the plate when any one of the reactive substrate and the washing buffer is injected to the flow channel, and the flow channel control means causes the transparent film to come closer to the surface of the plate when an image is taken by the imaging system.

7. The chemiluminescence analyzer according to claim 1, wherein
the transparent substrate contains a gel capable of volume change, and,
by controlling the volume of the gel, the flow channel control means increases a space between the plate and the transparent substrate when any one of the reactive substrate and the washing buffer is injected to the flow channel, and the flow channel control means decreases the space when an image is taken by the imaging system.

8. The chemiluminescence analyzer according to claim 1, wherein the chambers are concave portions formed on the surface of the plate.

9. The chemiluminescence analyzer according to claim 8, wherein the transparent substrate has concave portions formed thereon at respective positions facing the plurality of chambers formed on the plate.

10. The chemiluminescence analyzer according to claim 1, wherein the reactant is fixed on the surface of a bead and held in each of the chambers.

11. The chemiluminescence analyzer according to claim 10, wherein each of the chambers has a protrusion sticking out from the bottom part thereof.

12. The chemiluminescence analyzer according to claim 1, wherein
the plate is arranged on one surface of a substrate allowing permeation of the reactive substrate and the washing buffer,
the chambers are through holes provided in the plate, and
the other surface of the substrate, which is opposed to the surface in contact with the plate, is in contact with a second flow channel.

13. A chemiluminescence analyzer, comprising:
a plate having a plurality of chambers formed thereon;
a transparent substrate arranged to face the plate, the transparent substrate and the plate forming a flow channel in between;
an injecting unit for selectively injecting a reactive substrate and a washing buffer to the flow channel;
an imaging system for taking an image, through the transparent substrate, of luminescence due to a chemical reaction between a reactant held in each of the plurality of chambers provided in the plate and the reactive substrate supplied through the flow channel;
a flow-channel substrate arranged in the flow channel; and
a driving section for driving the flow-channel substrate, wherein
the driving section moves the flow-channel substrate to a position to open top openings of the plurality of chambers when any one of the reaction substrate and the washing buffer is injected to the flow channel, and
the driving section moves the flow-channel substrate to a position so as to shield the top openings of the plurality of chambers when an image is taken by the imaging system.

14. The chemiluminescence analyzer according to claim 13, wherein
the flow-channel substrate is a transparent plate, and
the driving section drives the flow-channel substrate in a direction perpendicular to a surface of the plate.

15. The chemiluminescence analyzer according to claim 14, wherein
the flow-channel substrate has a ferromagnetic body fixed thereon, and
the driving section drives the flow-channel substrate by magnetic force.

16. The chemiluminescence analyzer according to claim 13, wherein
the flow-channel substrate is a transparent plate having through holes corresponding to positions of the plurality of chambers, and
the driving section drives the flow-channel substrate in a direction parallel to a surface of the plate.

17. The chemiluminescence analyzer according to claim 16, wherein
the flow-channel substrate has a ferromagnetic body fixed thereon, and
the driving section drives the flow-channel substrate by magnetic force.

18. A chemiluminescence analyzer, comprising:
a plate having a plurality of chambers formed thereon;
a transparent substrate arranged to face the plate, the transparent substrate and the plate forming a flow channel in between;
an injecting unit for selectively injecting a reactive substrate and a washing buffer to the flow channel;
an imaging system for taking an image, through the transparent substrate, of luminescence due to a chemical reaction between a reactant held in each of the plurality of chambers provided in the plate and the reactive substrate supplied through the flow channel;
movable valves for opening and closing top openings of the plurality of chambers; and
a driving section for driving the movable valves, wherein
the driving section drives the movable valves so as to cause the movable valves to open top openings of the plurality of chambers when any one of the reactive substrate and the washing buffer is injected to the flow channel,
and the driving section drives the movable valves so as to cause the movable valves to shield the top openings of the plurality of chambers when an image is taken by the imaging system.

19. The chemiluminescence analyzer according to claim 18, wherein
the movable valves each have a transparent ferromagnetic body fixed thereon, and
the driving section drives the movable valves by magnetic force.
